(19) United States
(12) Patent Application Publication
(10) Pub. No.: US 2026/0094987 A1
(43) Pub. Date: Apr. 2, 2026

(54) LOADING MECHANISMS FOR LAND GRID ARRAY PACKAGES

(71) Applicant: Intel Corporation, Santa Clara, CA (US)

(72) Inventors: Luis Gil Rangel, Aloha, OR (US); Shyamjith Mohan, North Plains, OR (US); Jerrod Peterson, Hillsboro, OR (US); Joshua Triska, Hillsboro, OR (US)

(21) Appl. No.: 18/900,140

(22) Filed: Sep. 27, 2024

(51) Int. Cl. H01R 12/85

(52) U.S. Cl. CPC H01R 12/85

(57) ABSTRACT

A loading mechanism for a land grid array (LGA) semiconductor package can include a backplate configured to attach to a motherboard, a socket attached to the motherboard opposite the backplate, and a load plate configured to secure the LGA semiconductor package into the socket. The load plate can be removably coupled to the backplate and can include contact interfaces extending from the load plate and configured to contact the LGA semiconductor package when the LGA semiconductor package is loaded into the socket. The load plate can also include three or more spring elements configured to accommodate mechanical tolerances in one or more of the loading mechanism, the LGA semiconductor package, or the socket.

### BACKGROUND

Client desktop products can utilize advanced semiconductor packages that require precise electrical connections. These packages can feature contacts that are pressed down to establish connections with corresponding contacts in the receiving component. As the complexity and feature count of these products increases, the number of required contacts can also rise, necessitating greater mechanical force to ensure proper connectivity between the semiconductor package and the motherboard.

This increased force, combined with larger package sizes, can cause bending of the metal lid of the package. Bending can lead to non-uniform thermal interface material (TIM) thickness, negatively impacting thermal contact with the heatsink and overall processor performance. Existing solutions, such as the use of elevation components or bend correction frames, have various limitations, including an increased risk of poor electrical performance and high variation in applied force.

### BRIEF DESCRIPTION OF THE DRAWINGS

Various examples are illustrated in the figures of the accompanying drawings. Such examples are demonstrative and not intended to be exhaustive or exclusive examples of the present subject matter.

FIG. 1 illustrates an exploded view of an example of a loading mechanism for a land grid array (LGA) semiconductor package.

FIG. 2 illustrates a partial cross-sectional view of an example of a loading mechanism for a land grid array (LGA) semiconductor package.

FIG. 3 illustrates a bottom perspective view of an example of a load plate.

FIG. 4 illustrates examples of spring elements that can be used in a loading mechanism for a land grid array (LGA) semiconductor package.

FIG. 5 illustrates a perspective view of a land grid array (LGA) semiconductor package 102.

FIG. 6-11 illustrate examples of load plates that can be used in example loading mechanisms.

FIG. 12 illustrates an exploded view of an example of a loading mechanism including two leaf springs in the load plate.

FIG. 13 illustrates an example of a loading mechanism for a land grid array (LGA) semiconductor package.

FIG. 14 illustrates an enlarged view of a portion of an example of a loading mechanism.

FIG. 15 illustrates an example of the springs that can be used as the second spring element within the second spring attachment.

### DETAILED DESCRIPTION

Client Desktop products use land grid array (LGA) contacts on the bottom of the substrate, with the package physically pressed down by a loading mechanism to apply the appropriate mechanical force to make an electrical connection between the LGA semiconductor package contacts and a corresponding array of contacts in the motherboard socket. As products increase in feature count and complexity, there is a general trend over time to need a larger number of contacts, which in turn increases the required force that is applied by the loading mechanism. This increased force, combined with larger package sizes (e.g., XY size taking up additional area on the motherboard), can bend the metal lid of the LGA semiconductor package and can result in thick or non-uniform thermal interface material (TIM2). The thick or non-uniform thermal interface material can negatively impact thermal contact with the heatsink and the overall processor performance of the LGA semiconductor package.

Several approaches exist to address the bending of the integrated heat spreader (IHS) in LGA semiconductor packages, each with disadvantages. One common configuration involves the use of a “washer mod,” where washers are placed under the integrated loading mechanism (ILM) frame to elevate the ILM frame slightly higher above the motherboard, reducing ILM force and IHS bending. This approach can increase the risk of poor or unreliable socket electrical performance. Another configuration is the use of a bend correction frame (BCF), which clamps directly to the motherboard and is designed to contact the entire IHS flange. While popular with enthusiasts, these frames can be stiff and lack any type of spring element to absorb mechanical tolerances, resulting in high variation in the applied force and risk to package and socket reliability. Additionally, some manufacturers use a curved heatsink pedestal designed to match the curvature of the bent IHS, but this drives up heatsink cost and does not address the perception that the bent IHS contributes to poor thermal performance. Relying on the heatsink load as part of the overall loading mechanism solution is another approach, but this method requires tight control of the heatsink load, which is difficult to achieve due to the wide array of heatsink suppliers and designs in the ecosystem.

The proposed loading mechanism aims to address the IHS bending problem in a manner suitable for the client desktop ecosystem while avoiding the disadvantages of previous approaches. The design of the present disclosure can increase the number of contact points where the loading mechanism engages the package IHS from two to four or more. Additionally, the design of the present disclosure can increase the number of dedicated spring elements in the loading mechanism from one or fewer to two or more, which can ensure adequate compliance for accommodating mechanical tolerances and ensure sufficiently uniform loading of LGA semiconductor package within the socket. Thus, the present disclosure can reduce IHS bending, improve thermal performance, and maintain reliable electrical connections between the LGA semiconductor package and the motherboard.

In some examples, a loading mechanism for a land grid array (LGA) semiconductor package can include a backplate configured to attach to a motherboard; a socket attached to the motherboard opposite the backplate, the socket configured to receive an LGA semiconductor package; and a load plate configured to secure the LGA semiconductor package into the socket, the load plate removably coupled to the backplate, the load plate including contact interfaces extending from the load plate and configured to contact the LGA semiconductor package when the LGA semiconductor package is loaded into the socket, and three or more spring elements configured to accommodate mechanical tolerances in one or more of the loading mechanism, the LGA semiconductor package, or the socket.

In some examples, a loading mechanism for a land grid array (LGA) semiconductor package can include a backplate configured to attach to a motherboard; a socket attached to the motherboard opposite the backplate, the socket configured to receive an LGA semiconductor package; and a load plate configured to secure the LGA semiconductor package into the socket, the load plate removably coupled to the backplate, the load plate including contact interfaces extending from the load plate and configured to contact the LGA semiconductor package when the LGA semiconductor package is loaded into the socket, each contact interface of the contact interfaces configured to engage a different side of the LGA semiconductor package; and spring elements configured to provide compliance for accommodating mechanical tolerances in one or more of the loading mechanism, the LGA semiconductor package, or the socket.

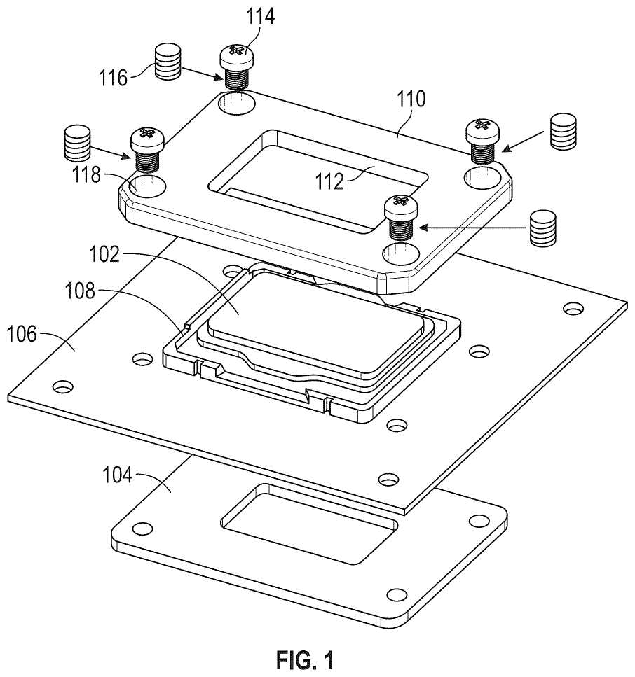

FIG. 1 illustrates an exploded view of a loading mechanism 100 for a land grid array (LGA) semiconductor package 102. The loading mechanism 100 can include a backplate 104 and a load plate 110. The backplate 104 can be attached to the underside of the motherboard 106 to provide structural support and distribute the load applied by the load plate 110. The loading mechanism 100 can be configured to load the LGA semiconductor package 102 into a socket 108 to ensure contact between the LGA semiconductor package 102 and a motherboard 106. The motherboard 106 can be the main circuit board that houses the socket 108 and other electronic components. The LGA semiconductor package 102 can be placed into the socket 108 on the motherboard 106. The socket 108 can be mounted on the motherboard 106 and be configured to receive the LGA semiconductor package 102. The socket 108 can have an array of spring contacts to make electrical connections with the contacts on the LGA semiconductor package 102.

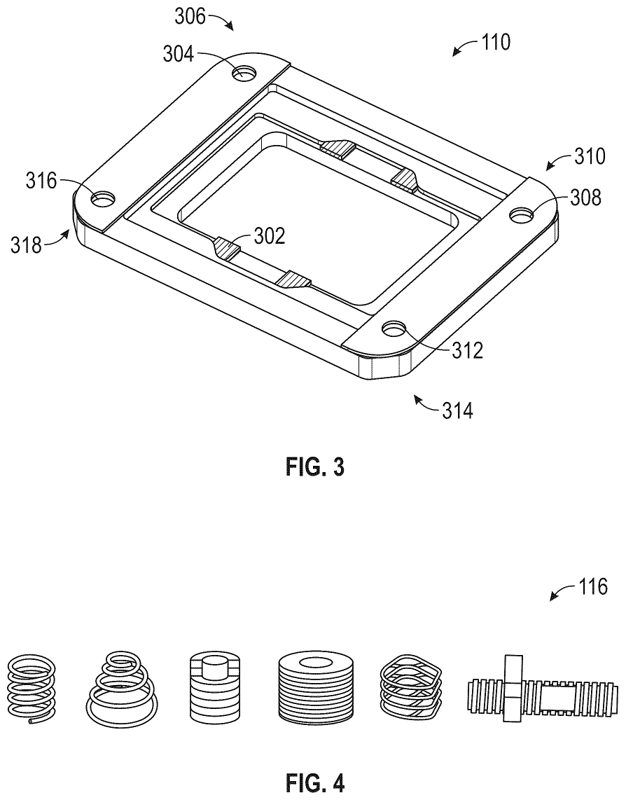

The load plate 110 can be positioned over the LGA semiconductor package 102 and can be used to apply a uniform load to secure the LGA semiconductor package 102 into the socket 108. The load plate 110 can have contact interfaces 112 that engage with the LGA semiconductor package 102. The contact interfaces 112 can be extensions from the load plate 110 that make contact with the LGA semiconductor package 102 to ensure it is properly seated in the socket 108. The contact interfaces 112 will be discussed in more detail in FIGS. 3 and 6-11.

Fasteners 114 can be used to secure the load plate 110 to the backplate 104. The fasteners 114 can pass through apertures 118 of the load plate 110 and engage with the backplate 104. Spring elements 116 can be positioned around the fasteners 114 and can provide compliance to accommodate mechanical tolerances in the loading mechanism 100, the LGA semiconductor package 102, or the socket 108. The spring elements 116 can help ensure a uniform load is applied by the load plate 110.

In operation, the LGA semiconductor package 102 can be placed into the socket 108 on the motherboard 106. The load plate 110 can then be positioned over the LGA semiconductor package 102, with the contact interfaces 112 engaging the package. The fasteners 114 can be inserted through the apertures 118 in the load plate 110 and secured to the backplate 104, with the spring elements 116 providing compliance to ensure a uniform load is applied. Thus, the spring elements 116 can be contained within the apertures 118 when the load plate 110 is attached to the backplate 104. This configuration can help ensure reliable electrical connections between the LGA semiconductor package 102 and the socket 108, while also minimizing bending of the package.

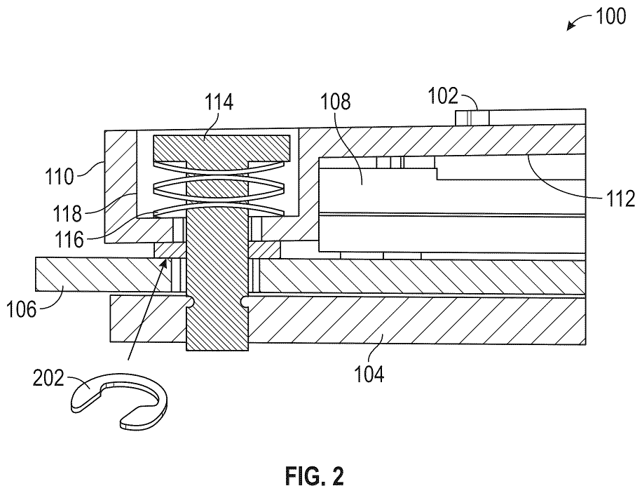

FIG. 2 illustrates a partial cross-sectional view of the loading mechanism 100 for a land grid array (LGA) semiconductor package 102. The loading mechanism 100 can include a retention feature 202 for each of the fasteners 114.

The retention feature 202 can be coupled to each fastener 114 to ensure that the spring elements 116 and the fasteners 114 are properly aligned and secured within the apertures 118. The retention feature 202 can help maintain the position of the spring elements 116 and prevent them from becoming dislodged during the loading or unloading of the LGA semiconductor package 102.

As shown in FIG. 2, the retention feature 202 can be a clip. In other examples, the retention feature 202 can be threads formed in the backplate 104, the motherboard 106, or the socket 108, which can engage with a threaded surface on each of the fasteners 114 (all shown in FIG. 1). Other forms of the retention feature 202 can also be deployed, such as different versions of a clip, or other means for retaining the fasteners 114 within the apertures 118 of the load plate 110.

FIG. 3 illustrates a bottom perspective view of a load plate 110. The load plate 110 can include contact interfaces 302, a first aperture 304 (e.g., of the apertures 118, FIG. 1), a first corner 306, a second aperture 308 (e.g., of the apertures 118, FIG. 1), a second corner 310, a third aperture 312 (e.g., of the apertures 118, FIG. 1), a third corner 314, a fourth aperture 316 (e.g., of the apertures 118, FIG. 1), and a fourth corner 318.

The contact interfaces 302 can be strategically positioned to engage with the LGA semiconductor package to ensure that the package is properly seated in the socket 108 (FIG. 1). The contact interfaces 302 can also be configured to provide a uniform load distribution to maintain reliable electrical connections between the LGA semiconductor package 102 and the motherboard 106 (both in FIG. 1).

The apertures 304, 308, 312, and 316 (e.g., the apertures 118. FIG. 1) can be configured to accommodate the fasteners 114 and the spring elements 116 that secure the load plate 110 to a backplate 104 attached to the underside of the motherboard 106. The fasteners 114 can pass through the apertures 304, 308, 312, and 316 and engage with the backplate 104 to ensure that the load plate 110 remains coupled to the backplate 104 and thus, the LGA semiconductor package 102 remains coupled to the motherboard 106 via the socket 108.

The first aperture 304 can be located at the first corner 306 of the load plate 110. The second aperture 308 can be located at the second corner 310, which can be laterally spaced from the first corner 306. The third aperture 312 can be located at the third corner 314, which can be aligned with the first aperture 304. The fourth aperture 316 can be located at the fourth corner 318, which can be aligned with the second corner 310 and laterally spaced from the third corner 314. Thus, as the apertures 304, 308, 312, and 316 surround the load plate 110, the apertures 304, 308, 312, and 314 can apply pressure evenly around the LGA semiconductor package 102 via the contact interfaces 302.

As shown in FIG. 3, the contact interfaces 302 can be formed in the load plate 110 such that they extend from the load plate 110 toward the LGA semiconductor package 102 when the LGA semiconductor package 102 is installed within the socket 108 and the load plate 110 is attached to the backplate 104. This configuration can ensure that the LGA semiconductor package 102 maintains a flat profile, which helps ensure optimal thermal performance and reliable electrical connections. The load plate 110, in combination with the fasteners 114 (FIG. 1) and backplate 104 (FIG. 1), can provide a robust solution for securing LGA semiconductor packages (e.g., the LGA semiconductor package 102) in high-performance computing environments.

FIG. 4 illustrates examples of spring elements 116 that can be used in a loading mechanism (e.g., the loading mechanism 100, FIG. 1) for a land grid array (LGA) semiconductor package (e.g., the LGA semiconductor package 102, FIG. 1). These spring elements 116 can provide compliance to accommodate mechanical tolerances in the loading mechanism, the LGA semiconductor package, or the socket by absorbing the force generated by the mechanical tolerances to ensure consistent pressure is applied by the load plate 110 to the LGA semiconductor package 102.

The spring elements 116 can include various types of springs, each designed to offer specific mechanical properties. The first spring element can be a coil spring, which can provide linear force and is commonly used for simplicity and effectiveness in various applications. The second spring element can be a conical spring, which can offer a compact design and can provide a variable force depending on the compression level. The third spring element can be a disc washer, which can be used in stacked configurations to provide a high load capacity in a small space. The fourth spring element can be a disc-wave spring, which can offer a consistent force over a range of deflections and can be used in applications requiring precise load control. The fifth spring element can be a poly-wave spring, which can provide a combination of high load capacity and flexibility, making the poly-wave spring suitable for applications with varying load requirements. The sixth spring element can be a proprietary spring design, which can be customized to meet specific mechanical and load requirements of the loading mechanism.

These spring elements 116 can be strategically positioned around fasteners (e.g., the fasteners 114) in the loading mechanism (e.g., the loading mechanism 100) to ensure a uniform load is applied to the LGA semiconductor package (e.g., the LGA semiconductor package 102). This configuration can help maintain reliable electrical connections and minimize package (e.g., the LGA semiconductor package 102) bending, thereby improving the thermal performance and overall reliability of the LGA semiconductor package 102.

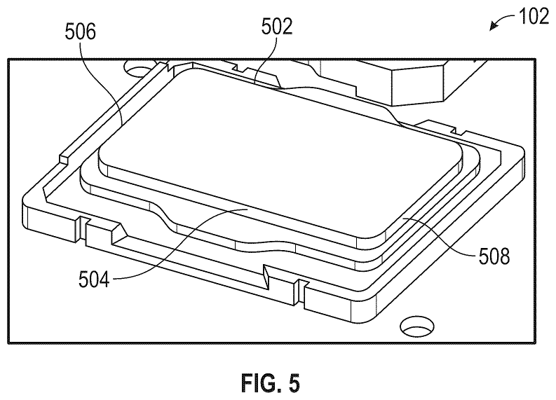

FIG. 5 illustrates a perspective view of a land grid array (LGA) semiconductor package 102. The LGA semiconductor package 102 can include a first side 502, a second side 504, a third side 506, and a fourth side 508. The sides 502, 504, 506, and 508 can define the perimeter of the LGA semiconductor package 102.

The first side 502 and the second side 504 can be positioned opposite each other, while the third side 506 and the fourth side 508 can extend between the first side 502 and the second side 504. This configuration allows the LGA semiconductor package 102 to be securely seated in the socket, ensuring that all electrical contacts are properly aligned and engaged. As discussed herein, the contact interfaces 302 can be configured to contact with various sides of the sides 502, 504, 506, and 508 to ensure proper loading of the LGA semiconductor package 102 within the socket 108 (FIG. 1).

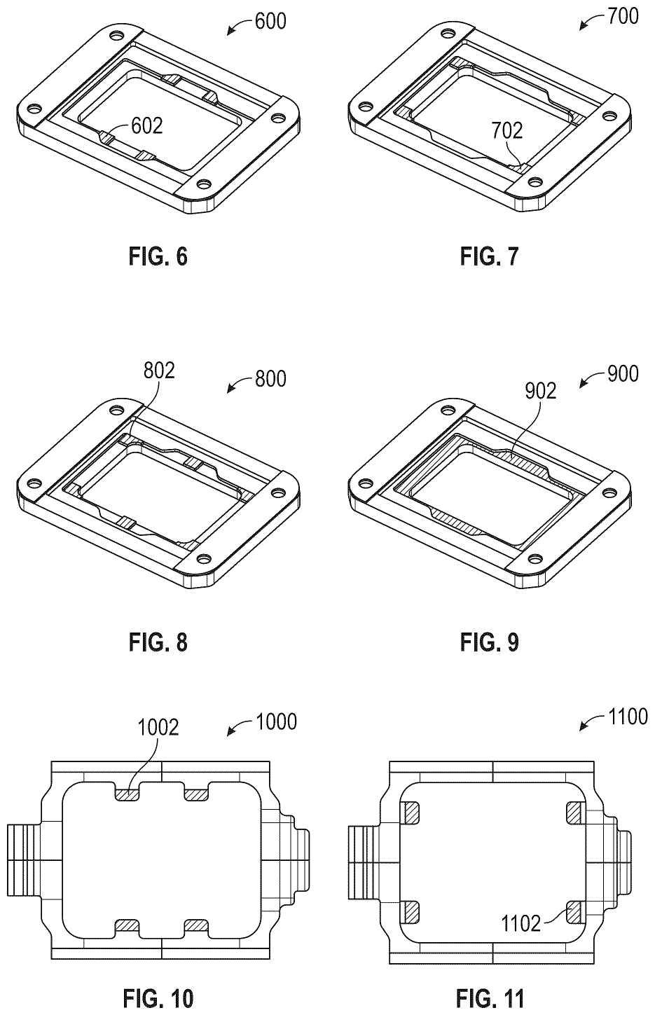

FIG. 6-11 illustrate examples of load plates (e.g., the load plate 110, see FIG. 1) that can be used in the loading mechanism (e.g., the loading mechanism 100, FIG. 1).

FIG. 6 illustrates a load plate 600 (e.g., the load plate 110) with contact interfaces 602 (e.g., the contact interfaces 302, FIG. 3). The contact interfaces 602 can be configured to engage with the first side 502 and the second side 504 of the LGA semiconductor package 102 (FIG. 1). This configuration can help ensure proper seating and uniform load distribution transferred from the load plate 600 to the LGA semiconductor package 102 to maintain reliable electrical connections and minimize bending of the LGA semiconductor package 102.

FIG. 7 illustrates a load plate 700 (e.g., the load plate 110) with contact interfaces 702 (e.g., the contact interfaces 302, FIG. 3). The contact interfaces 702 can be configured to contact all four corners of the LGA semiconductor package 102. This design can enhance the stability and uniformity of the load applied by the load plate 700, reducing the risk of bending the LGA semiconductor package 102 to ensure consistent electrical performance.

FIG. 8 illustrates a load plate 800 (e.g., the load plate 110) with contact interfaces 802 (e.g., the contact interfaces 302, FIG. 3). The contact interfaces 802 can be symmetrically spread along the first side 502 and the second side 504 of the LGA semiconductor package 102. This configuration can help provide a balanced load distribution across the LGA semiconductor package 102 to maintain flatness of the LGA semiconductor package 102 for optimal thermal performance and reliable electrical connections.

FIG. 9 illustrates a load plate 900 (e.g., the load plate 110) with the contact interface 902 (e.g., the contact interfaces 302, FIG. 3). The contact interface 902 can be configured to engage around the entire perimeter of the LGA semiconductor package 102. Thus, the contact interface 902 can be configured to engage all of the sides 502, 504, 506, and 508 continuously. This design can ensure a uniform load is applied, minimizing bending and maintaining the integrity of the electrical connections.

FIG. 10 illustrates a load plate 1000 with contact interfaces 1002 (e.g., the contact interfaces 302, FIG. 3). The contact interfaces 1002 can be spaced along the first side 502 and the second side 504 of the LGA semiconductor package 102. This configuration can help distribute the load evenly, maintaining the flatness of the package and improving thermal performance and electrical reliability.

FIG. 11 illustrates a load plate 1100 with contact interfaces 1102 (e.g., the contact interfaces 302, FIG. 3). The contact interfaces 1102 can be configured to engage with the third side 506 and the fourth side 508 of the LGA semiconductor package 102. This design can ensure a uniform load distribution, reducing the risk of bending and maintaining reliable electrical connections.

These figures are just examples, and other load plates with different configurations of contact interfaces are considered part of the disclosure. For instance, a load plate can include contact interfaces positioned at six or more discrete points around the LGA semiconductor package 102 (FIG. 1), or the load plate can include contact interfaces that provide continuous contact along the entire perimeter of the LGA semiconductor package 102. Additionally, contact interfaces can be arranged in various symmetrical or asymmetrical patterns to suit different design requirements and ensure optimal load distribution and electrical performance.

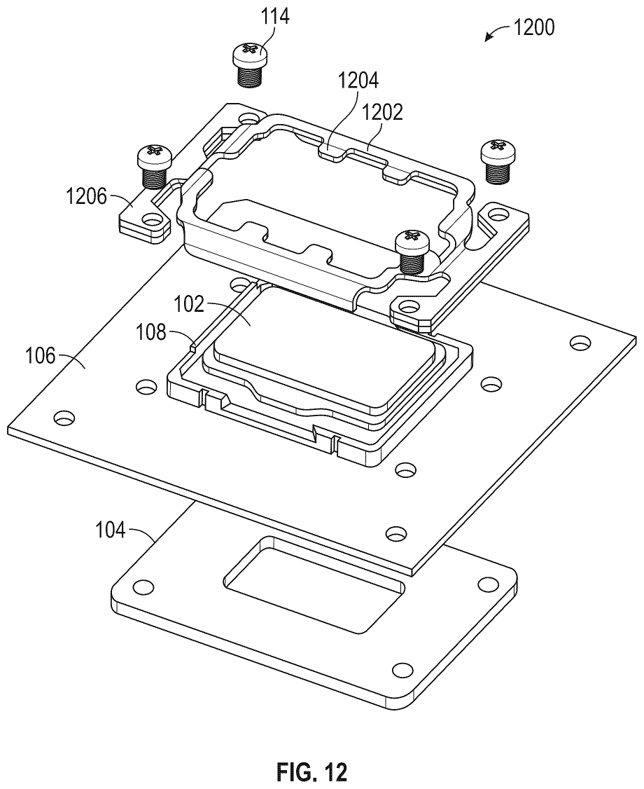

FIG. 12 illustrates an exploded view of an example of a loading mechanism 1200. The loading mechanism 1200 can be configured to receive the LGA semiconductor package 102. The loading mechanism 1200 can include a backplate 104, a motherboard 106, a socket 108, fasteners 114, a load plate 1202, and spring elements 1206.

The LGA semiconductor package 102 can be designed to fit into the socket 108, which can be mounted on the motherboard 106. The socket 108 can contain an array of spring contacts that make electrical connections with the contacts on the LGA semiconductor package 102. The backplate 104 can be attached to the underside of the motherboard 106 to provide structural support and distribute the load applied by the load plate 1202.

The load plate 1202 can be positioned over the LGA semiconductor package 102 to apply a uniform load to secure the LGA semiconductor package 102 into the socket 108. The load plate 1202 can include contact interfaces 1204 that engage with the LGA semiconductor package 102 to ensure the LGA semiconductor package 102 is properly seated in the socket 108. The contact interfaces 1204 can extend from the load plate 1202 and be configured to engage the LGA semiconductor package 102.

Fasteners 114 can be used to secure the load plate 1202 to the backplate 104. The fasteners 114 can pass through apertures in the load plate 1202 and engage with the backplate 104.

The load plate 1202 can include spring elements 1206. The spring elements 1206 can help ensure a uniform load is applied by the load plate 1202. The spring elements 1206 can be integral to the load plate 1202 or attached to the load plate 1202. When integral, the spring elements 1206 can be formed as part of the load plate 1202 during the manufacturing process. When attached, the spring elements 1206 can be secured to the load plate 1202 using methods such as welding, riveting, adhesive bonding, or the like.

In some examples, the spring elements 1206 can be configured to bend as the load plate 1202 is attached to the backplate 104. In this configuration, the spring elements 1206 can start in a flat or slightly curved state and bend as the fasteners 114 are tightened, providing the necessary compliance to accommodate mechanical tolerances.

In some examples, the spring elements 1206 can be biased toward a bent configuration and flatten as the load plate 1202 is attached to the backplate 104. In this configuration, the spring elements 1206 can start in a pre-bent state and flatten as the fasteners 114 are tightened, ensuring a uniform load is applied to the LGA semiconductor package 102.

In operation, the LGA semiconductor package 102 can be placed into the socket 108 on the motherboard 106. The load plate 1202 can then be positioned over the LGA semiconductor package 102, with the contact interfaces 1204 engaging the package. The fasteners 114 can be inserted through the apertures in the load plate 1202 and secured to the backplate 104, with the spring elements 1206 providing compliance to ensure a uniform load is applied. This configuration can help ensure reliable electrical connections between the LGA semiconductor package 102 and the socket 108, while also minimizing bending of the package.

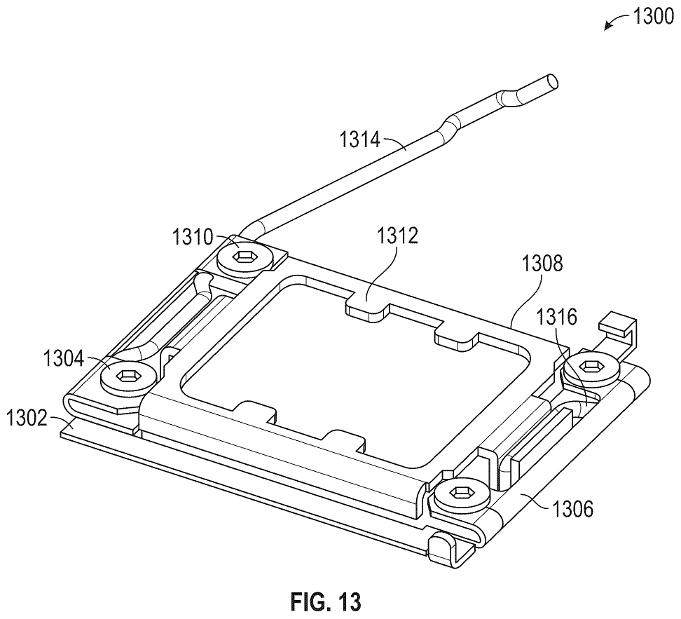

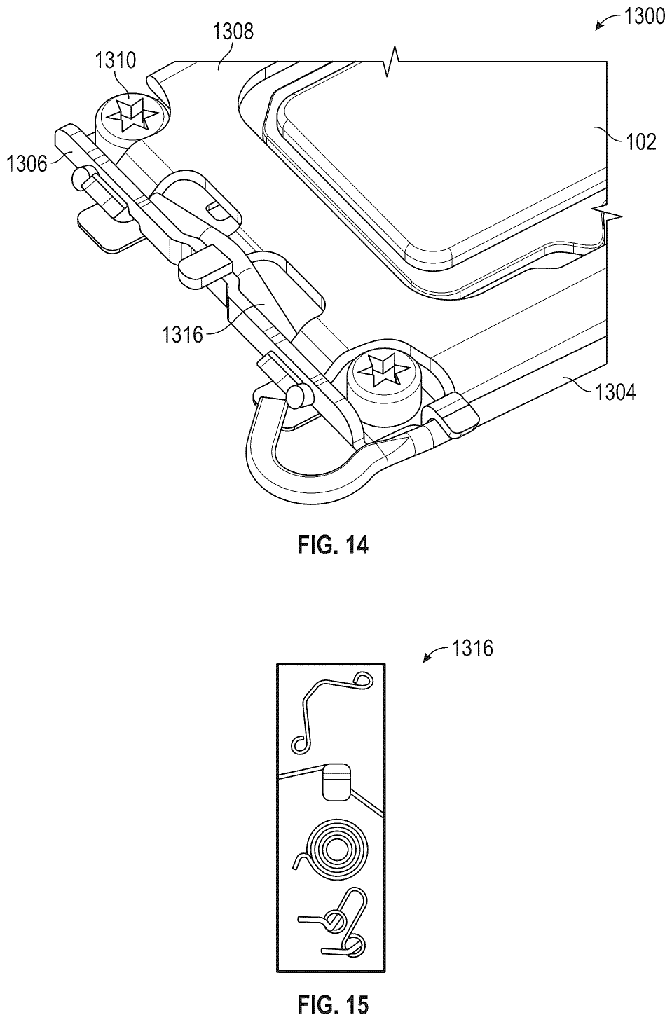

FIG. 13 and FIG. 14 will be discussed together below. FIG. 13 illustrates a loading mechanism 1300 for a land grid array (LGA) semiconductor package. FIG. 14 illustrates show an enlarged view of a portion of the load assembly from FIG. 13.

The loading mechanism 1300 can include a frame 1302, a first spring attachment 1304, a second spring attachment 1306, a load plate 1308, fasteners 1310, contact interfaces 1312, a first spring element 1314, and a second spring element 1316.

The frame 1302 can provide structural support and alignment for the loading mechanism 1300. The first spring attachment 1304 and the second spring attachment 1306 can be configured to secure the first spring element 1314 and the second spring element 1316, respectively to the loading mechanism 1300 to couple the load plate 1308 to the frame 1302. The load plate 1308 can be designed to apply a uniform load to the LGA semiconductor package 102 to ensure proper seating and electrical contact within the socket.

The fasteners 1310 can be used to secure the first spring element 1314 and the second spring element 1316 to the first spring attachment 1304 and the second spring attachment 1306, respectively, to attach the first spring element 1314 and the second spring element 1316 to the frame 1302. These fasteners 1310 can pass through apertures in the frame 1302 to secure the frame 1302 to a back plate (e.g., the backplate 104, FIG. 1) or the motherboard (e.g., the motherboard 106, FIG. 1). The contact interfaces 1312 can extend from the load plate 1308 and can be configured to contact the LGA semiconductor package (e.g., the LGA semiconductor package 102, FIG. 1) to ensure the LGA semiconductor package 102 is properly seated in the socket (e.g., the socket 108, FIG. 1).

In some examples, the first spring element 1314 can be a lever spring, which can provide compliance and ensure a uniform load is applied to the LGA semiconductor package. The second spring element 1316 can be a yoke spring, which can also provide compliance and help distribute the load evenly across the package. These spring elements can accommodate mechanical tolerances in the loading mechanism 1300, the LGA semiconductor package, or the socket, ensuring reliable electrical connections and minimizing bending of the package.

As shown in FIG. 13, the first spring attachment 1304 can be attached to a first side of the frame 1302 to position the first spring element 1314 to secure a first end of the LGA semiconductor package 102 within the loading mechanism 1300. The second spring attachment 1306 can be attached to a second side of the frame 1302, opposite the first side of the frame 1302 to position the second spring element 1316 and secure a second end of the LGA semiconductor package 102, which can be opposite the first end of the LGA semiconductor package 102. In such an arrangement, the second spring element 1316 can be secured into the second spring attachment 1306 and the first spring element 1314 can be pivotably coupled to the first spring attachment 1304.

As shown in FIG. 14, the LGA semiconductor package 102 can be loaded into the socket (e.g., the socket 108, FIG. 1) and the load plate 1308 can be installed by swinging the first spring element 1314 to attach to the frame adjacent to the second side of the frame 1302 adjacent to the second spring attachment 1306. After the first spring element 1314 is attached to the second side of the frame 1302, the LGA semiconductor package 102 can be completely installed within the loading mechanism 1300.

FIG. 15 illustrates example springs that can be used as the second spring element 1316 in the second spring attachment. The figure illustrates various types of springs that can provide compliance and ensure a uniform load is applied to the LGA semiconductor package. These springs can accommodate mechanical tolerances in the loading mechanism, the LGA semiconductor package, or the socket, ensuring reliable electrical connections and minimizing bending of the package.

The second spring element 1316 can be a yoke spring, which can provide controlled compliance and is suitable for applications requiring precise load control. The other types depicted are various examples of torsional springs, which can offer linear force and are commonly used for simplicity and effectiveness in various applications. Additionally, the second spring element 1316 can also include coil springs, conical springs, disc washers, disc-wave springs, poly-wave springs, or the like. The second spring element 1316 can be strategically positioned around fasteners in the loading mechanism to ensure a uniform load is applied to the LGA semiconductor package. This configuration can help maintain reliable electrical connections and minimize bending of the package, thereby improving thermal performance and overall reliability of the semiconductor package.

The following, non-limiting examples, detail certain aspects of the present subject matter to solve the challenges and provide the benefits discussed herein, among others.

Example 1 is a loading mechanism for a land grid array (LGA) semiconductor package, comprising: a backplate configured to attach to a motherboard; a socket attached to the motherboard opposite the backplate, the socket configured to receive an LGA semiconductor package; and a load plate configured to secure the LGA semiconductor package into the socket, the load plate removably coupled to the backplate, the load plate including: contact interfaces extending from the load plate and configured to contact the LGA semiconductor package when the LGA semiconductor package is loaded into the socket, and three or more spring elements configured to accommodate mechanical tolerances in one or more of the loading mechanism, the LGA semiconductor package, or the socket.

In Example 2, the subject matter of Example 1 optionally includes wherein the load plate comprises: apertures extending through the load plate; and fasteners configured to couple the load plate to the backplate, each fastener of the fasteners configured to extend through the apertures of the load plate to couple the load plate to the backplate.

In Example 3, the subject matter of Example 2 optionally includes wherein each spring element of the three or more spring elements is configured to be installed around each fastener of the fasteners.

In Example 4, the subject matter of Example 3 optionally includes a retention feature configured to be coupled to each fastener of the fasteners such that the retention feature and the respective spring element are installed on opposing sides of the load plate.

In Example 5, the subject matter of any one or more of Examples 1-4 optionally include wherein the three or more spring elements comprise axial springs, including one or more coil springs, conical springs, disc washers, disc-wave springs, or poly-wave springs.

In Example 6, the subject matter of any one or more of Examples 1-5 optionally include wherein the contact interfaces includes: a first contact interface configured to engage with a first side of the LGA semiconductor package; a second contact interface configured to engage with a second side of the LGA semiconductor package, the second side opposite the first side; a third contact interface configured to engage with a third side of the LGA semiconductor package, the third side extending from the first side to the second side; and a fourth contact interface configured to engage with a fourth side of the LGA semiconductor package, the fourth side extending from the first side to the second side opposite the third side.

In Example 7, the subject matter of any one or more of Examples 1-6 optionally include wherein the contact interfaces includes: a first contact interface configured to engage with a first side of the LGA semiconductor package; a second contact interface configured to engage with a second side of the LGA semiconductor package, the second side opposite the first side; a third contact interface configured to engage with a third side of the LGA semiconductor package, the third side extending from the first side to the second side; a fourth contact interface configured to engage with a fourth side of the LGA semiconductor package, the fourth side extending from the first side to the second side opposite the third side; a fifth contact interface configured to engage with the first side of the LGA semiconductor package; and a sixth contact interface configured to engage with the second side of the LGA semiconductor package.

In Example 8, the subject matter of any one or more of Examples 1-7 optionally include wherein the contact interfaces are configured to engage the LGA semiconductor package at six or more discrete points surrounding the LGA semiconductor package.

In Example 9, the subject matter of any one or more of Examples 1-8 optionally include wherein the contact interfaces are configured to contact the LGA semiconductor package along a continuous perimeter of an integrated heat spreader (IHS) of the LGA semiconductor package.

In Example 10, the subject matter of any one or more of Examples 1-9 optionally include wherein the contact interfaces are symmetrically arranged to surround the LGA semiconductor package.

In Example 11, the subject matter of any one or more of Examples 2-10 optionally include wherein the apertures includes: a first aperture extending through a first corner of the load plate; a second aperture extending through a second corner of the load plate, the second corner of the load plate laterally spaced from the first corner of the load plate; a third aperture extending through a third corner of the load plate, the third corner aligned with the first aperture; and a fourth aperture extending through a fourth corner of the load plate, the fourth corner aligned with the second corner and laterally spaced from the third corner.

Example 12 is a loading mechanism for a land grid array (LGA) semiconductor package, comprising: a backplate configured to attach to a motherboard; a socket attached to the motherboard opposite the backplate, the socket configured to receive a LGA semiconductor package; and a load plate configured to secure the LGA semiconductor package into the socket, the load plate removably coupled to the backplate, the load plate including: contact interfaces extending from the load plate and configured to contact the LGA semiconductor package when the LGA semiconductor package is loaded into the socket, each contact interface of the contact interfaces configured to engage a different side of the LGA semiconductor package; and spring elements configured to provide compliance for accommodating mechanical tolerances in one or more of the loading mechanism, the LGA semiconductor package, or the socket.

In Example 13, the subject matter of Example 12 optionally includes wherein the spring elements include a combination of axial springs and leaf springs integrated with the load plate.

In Example 14, the subject matter of any one or more of Examples 12-13 optionally include wherein the spring elements include leaf springs integrated with the load plate.

In Example 15, the subject matter of any one or more of Examples 12-14 optionally include wherein the spring elements include leaf springs coupled to the load plate.

In Example 16, the subject matter of any one or more of Examples 12-15 optionally include a frame coupled to the motherboard opposite the backplate, the frame including: a first spring attachment; and a second spring attachment.

In Example 17, the subject matter of Example 16 optionally includes wherein the spring elements comprise: a lever spring configured to be installed within the first spring attachment, the lever spring operable between an open position and a closed position, in the open position, the lever spring configured to permit movement of the load plate relative to the frame to enable loading of the LGA semiconductor package into the socket, and in the closed position, configured to secure a first end portion of the load plate to limit or prevent movement of the load plate relative to the socket; and a yoke spring configured to be installed within the second spring attachment, the yoke spring configured to secure a second end portion of the load plate to limit or prevent movement of the load plate relative to the socket.

In Example 18, the subject matter of any one or more of Examples 12-17 optionally include wherein the contact interfaces are configured to contact the LGA semiconductor package at six or more discrete points around the LGA semiconductor package.

In Example 19, the subject matter of any one or more of Examples 12-18 optionally include wherein the contact interfaces are configured to engage the LGA semiconductor package along a perimeter of an integrated heat spreader (IHS) of the LGA semiconductor package.

In Example 20, the subject matter of any one or more of Examples 12-19 optionally include wherein the contact interfaces are symmetrically arranged to surround the LGA semiconductor package.

Example 21 includes a method, device, system, or the like including any element of any of Examples 1-20.

1The above-detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. 1Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

1. A loading mechanism for a land grid array (LGA) semiconductor package, comprising:
a backplate configured to attach to a motherboard;
a socket attached to the motherboard opposite the backplate, the socket configured to receive an LGA semiconductor package; and
a load plate configured to contain the LGA semiconductor package in the socket, the load plate removably coupled to the backplate, the load plate including:
contact interfaces extending from the load plate and configured to contact the LGA semiconductor package when the LGA semiconductor package is in the socket, and
three or more spring elements configured to provide mechanical tolerances in one or more of the loading mechanism, the LGA semiconductor package, or the socket.

2. The loading mechanism of claim 1, wherein the load plate comprises:
apertures extending through the load plate; and
fasteners configured to couple the load plate to the backplate, wherein the the fasteners are configured to extend through the apertures of the load plate to couple the load plate to the backplate.

3. The loading mechanism of claim 2, wherein the three or more spring elements are configured to be installed around the fasteners. The loading mechanism of claim 3, comprising:
a retention feature configured to be coupled to the fasteners to install the retention feature and the respective spring element on opposing sides of the load plate.

5. The loading mechanism of claim 1, wherein the three or more spring elements comprise axial springs, including one or more coil springs, conical springs, disc washers, disc-wave springs, or poly-wave springs.

6. The loading mechanism of claim 1, wherein the contact interfaces includes:
a first contact interface configured to engage with a first side of the LGA semiconductor package;
a second contact interface configured to engage with a second side of the LGA semiconductor package, the second side opposite the first side;
a third contact interface configured to engage with a third side of the LGA semiconductor package, the third side extending from the first side to the second side; and
a fourth contact interface configured to engage with a fourth side of the LGA semiconductor package, the fourth side extending from the first side to the second side opposite the third side.

7. The loading mechanism of claim 1, wherein the contact interfaces includes:
a first contact interface configured to engage with a first side of the LGA semiconductor package;
a second contact interface configured to engage with a second side of the LGA semiconductor package, the second side opposite the first side;
a third contact interface configured to engage with a third side of the LGA semiconductor package, the third side extending from the first side to the second side;
a fourth contact interface configured to engage with a fourth side of the LGA semiconductor package, the fourth side extending from the first side to the second side opposite the third side;
a fifth contact interface configured to engage with the first side of the LGA semiconductor package; and
a sixth contact interface configured to engage with the second side of the LGA semiconductor package.

8. The loading mechanism of claim 1, wherein the contact interfaces are configured to engage the LGA semiconductor package at six or more discrete points surrounding the LGA semiconductor package.

9. The loading mechanism of claim 1, wherein the contact interfaces are configured to contact the LGA semiconductor package along a continuous perimeter of the LGA semiconductor package.

10. The loading mechanism of claim 1, wherein the contact interfaces are symmetrically arranged to surround the LGA semiconductor package.

11. The loading mechanism of claim 2, wherein the apertures includes:
a first aperture extending through a first corner of the load plate;
a second aperture extending through a second corner of the load plate, the second corner of the load plate laterally spaced from the first corner of the load plate;
a third aperture extending through a third corner of the load plate, the third corner aligned with the first aperture; and
a fourth aperture extending through a fourth corner of the load plate, the fourth corner aligned with the second corner and laterally spaced from the third corner.

12. A loading mechanism for a land grid array (LGA) semiconductor package, comprising:
a backplate configured to attach to a motherboard;
a socket attached to the motherboard opposite the backplate, the socket configured to receive a LGA semiconductor package; and
a load plate configured to hold the LGA semiconductor package in the socket, the load plate removably coupled to the backplate, the load plate including:
contact interfaces extending from the load plate and configured to contact the LGA semiconductor package when the LGA semiconductor package is in the socket, each contact interface of the contact interfaces configured to engage a different side of the LGA semiconductor package; and
spring elements configured to provide mechanical tolerances in one or more of the loading mechanism, the LGA semiconductor package, or the socket.

13. The loading mechanism of claim 12, wherein the spring elements include a combination of axial springs and leaf springs integrated with the load plate.

14. The loading mechanism of claim 12, wherein the spring elements include leaf springs integrated with the load plate.

15. The loading mechanism of claim 12, wherein the spring elements include leaf springs coupled to the load plate.

16. The loading mechanism of claim 12, comprising:
a frame coupled to the motherboard opposite the backplate, the frame including:
a first spring attachment; and
a second spring attachment.

17. The loading mechanism of claim 16, wherein the spring elements comprise:
a lever spring configured to be installed within the first spring attachment, the lever spring operable between an open position and a closed position, in the open position, the lever spring configured to permit movement of the load plate relative to the frame to enable loading of the LGA semiconductor package into the socket, and in the closed position, configured to secure a first end portion of the load plate to limit or prevent movement of the load plate relative to the socket; and
a yoke spring configured to be installed within the second spring attachment, the yoke spring configured to secure a second end portion of the load plate to limit or prevent movement of the load plate relative to the socket.

18. The loading mechanism of claim 12, wherein the contact interfaces are configured to contact the LGA semiconductor package at six or more discrete points around the LGA semiconductor package.

19. The loading mechanism of claim 12, wherein the contact interfaces are configured to engage the LGA semiconductor package along a perimeter of an integrated heat spreader (IHS) of the LGA semiconductor package.

20. The loading mechanism of claim 12, wherein the contact interfaces are symmetrically arranged to surround the LGA semiconductor package.
